(19) United States
(12) Patent Application Publication
(10) Pub. No.: US 2009/0211391 A1
(43) Pub. Date: Aug. 27, 2009

(54) Balanced force control cable assembly

(76) Inventor: Mark W. Stevenson, Appleton, NY (US)

Correspondence Address: DELPHI TECHNOLOGIES, INC., M/C 480-410-202, PO BOX 5052, TROY, MI, 48007, US

(21) Appl. No.: 12/072,242

(22) Filed: Feb. 25, 2008

(51) Int. Cl. G05G 11/00; B60H 1/00

(52) U.S. Cl. 74/490.14

(57) ABSTRACT

A balanced force control cable assembly comprising a first lever rotatably mounted in a first housing and a second lever rotatably mounted in a second housing. A control knob for selecting a temperature is attached to the first lever. A cable extends from the first lever to the second lever for rotating the second lever in response to the rotation of the control knob. A first spring engages the first housing and the first lever for applying a first pre-determined force to continually bias the first lever to rotate in a first direction. A second spring engages the second housing and the second lever for applying a second predetermined force in a second direction being opposite to the first direction to counterbalance the first spring and to maintain tension in the cable.

### BACKGROUND OF THE INVENTION

1. Field of the Invention

The present invention relates to a control cable assembly for use in a heating and ventilation and air conditioning (HVAC) unit.

2. Description of the Prior Art

The cable assemblies used to manually control the temperature in the HVAC unit often include levers in the form of pulleys operatively connected to one another through cables. One such cable assembly is disclosed in U.S. Pat. No. 4,936,159, issued on Jun. 26, 1990 to Kallio (hereinafter referred to as Kallio '159). The Kallio '159 patent discloses a cable assembly including a first pulley attached to a control knob and disposed in a first housing and a second pulley disposed in a second housing and attached to a temperature control device and a cable having a first cable end attached to the first pulley and entrained around the second pulley and back to the first pulley for turning the second pulley in response to the rotation of control knob. In operation, one reach of the cable is in tension and rotates the second pulley when the control knob is turned in one direction and the other reach of the cable is in tension and rotates the second pulley when the control knob is turned in the other direction. A spring reacts between one of the ends of the cable and the first pulley for taking up slack and maintaining tension in the cable.

A common problem with the prior art assemblies is that the pulley sizes often do not provide enough leverage force for actuation while keeping manual input effort low. HVAC systems need to be carefully designed to allow for these lowered forces. A cable assembly having a two reach cable may provide slightly reduced responsiveness due to small amounts of slack in the cables when changing direction.

### SUMMARY OF THE INVENTION AND ADVANTAGES

The invention relates to such a control cable assembly including a first spring engaging the first housing and the first lever for applying a first pre-determined force to continually bias the first lever to rotate in a first direction, and a second spring engages the second housing and the second lever for applying a second pre-determined force to continually bias the second lever to rotate in a second direction opposite to the first direction for maintaining tension in the cable and for counterbalancing the first spring.

When the control knob is turned in the first direction, tension is transmitted through the cable and both springs to rotate the first lever with the second lever. When the control knob is then rotated in the second or opposite direction, some of the biasing force being exerted on the cable by the first spring is relieved whereby the second spring rotates the second lever to maintain the cable in tension. Due to spring loading, the cable is always under tension and no slack occurs in the system, particularly when manual input relieves the first spring. By using balanced springs to provide the necessary forces, the operator needs very little effort for actuation because the manual input unbalances the springs thereby using spring force to move the cable and levers.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of the invention;

FIG. 2 is a perspective and exploded view of the second housing and the second lever and the second cover and the second spring and the second shield;

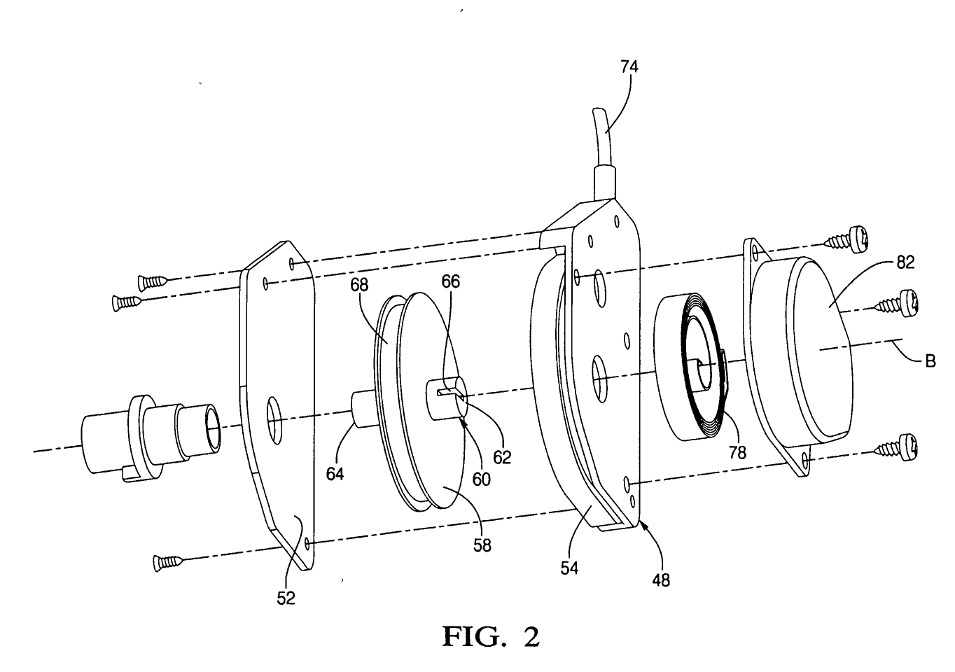

FIG. 3 is a perspective and exploded view of the first housing and the first lever and the first cover and the first spring and the first shield; and

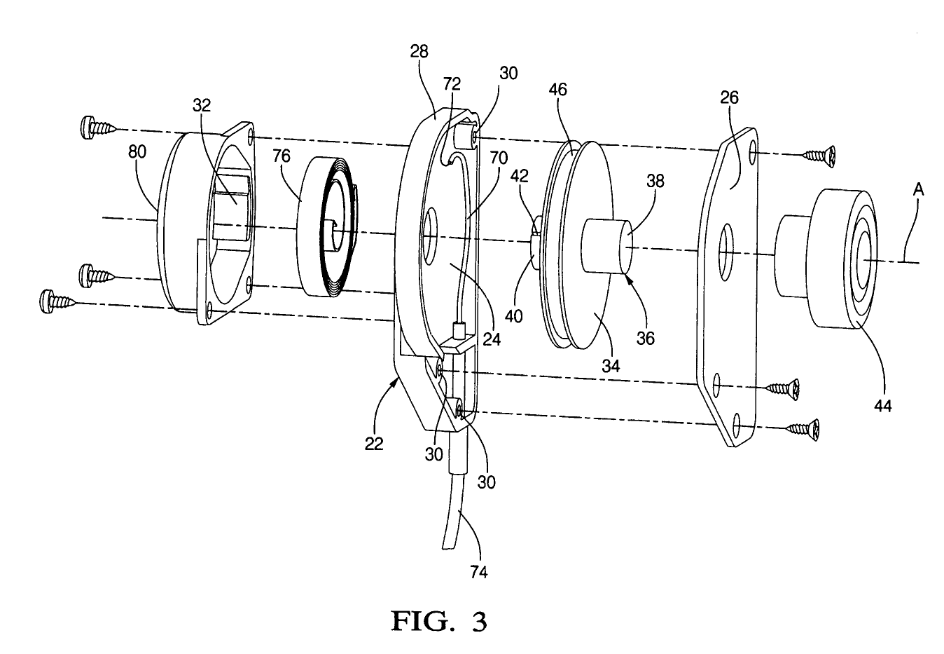

FIG. 4 is a front elevational of the invention without the covers.

### DETAILED DESCRIPTION OF THE INVENTION

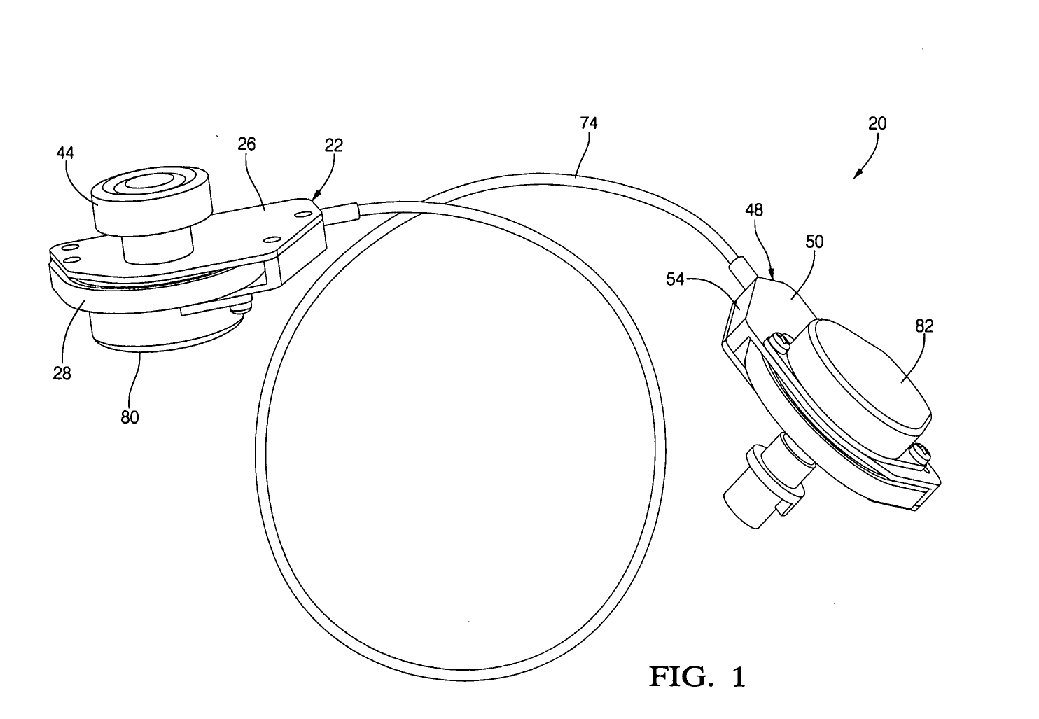

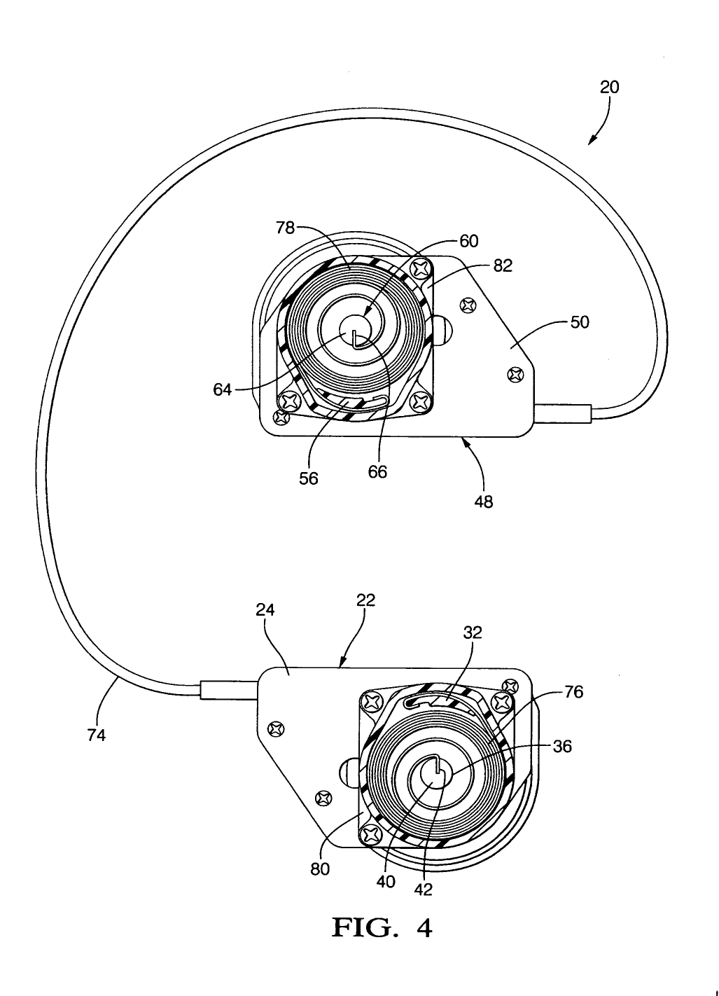

Referring to the Figures, wherein like numerals indicate corresponding parts throughout the several views, a cable assembly 20 for rotating a temperature control device in response to a rotating input is generally shown in FIGS. 1 and 4.

The cable assembly 20 includes a first housing 22, which is generally indicated, having a first bottom wall 24 and a first cover 26. The first housing 22 includes a first peripheral wall 28 extending upwardly from the inside of the first bottom wall 24. A plurality of first abutments 30 extend upwardly from the first bottom wall 24 for receiving screws, and a first pin 32 extends upwardly from the first bottom wall 24. The first cover 26 engages the first peripheral wall 28 to close the first housing 22, and a plurality of screws extend through the first cover 26 to threadedly engage the first abutments 30.

A first lever 34 for receiving a rotating input is rotatably disposed on a first axis A and mounted to the first housing 22 between the first bottom wall 24 and the first cover 26. The first lever 34 has a first shaft 36, which is generally indicated, extending axially upward along the first axis A through the first cover 26 to a first shaft top end 38 and axially downward through the first bottom wall 24 to a first shaft bottom end 40. The first shaft bottom end 40 presents a first slot 42 extending across the first shaft bottom end 40.

A control knob 44, or any other input device capable of rotating the first lever 34, is attached to the first shaft top end 38 for rotating the first lever 34 to select a temperature.

In the preferred embodiment, the first lever 34 is a pulley having a circular shape and having a first radius and a first circumference. The first pulley 34 presents a first channel 46 disposed along the first circumference of the first pulley 34.

The assembly also includes a second housing 48, which is generally indicated, having a second bottom wall 50 and a second cover 52. The second housing 48 includes a second peripheral wall 54 extending upwardly from the inside of the second bottom wall 50. The second cover 52 engages the second peripheral wall 54 to close the second housing 48. A plurality of second abutments extend upwardly from the second bottom wall 50 for receiving screws, and a second pin 56 extends upwardly from the second bottom wall 50. A plurality of screws extend through the second cover 52 to threadedly engage the second abutments.

A second lever 58 is rotatably disposed about a second axis B and is mounted to the second housing 48 between the second cover 52 and the second bottom wall 50. The second lever 58 includes a second shaft 60, which is generally indicated, extending along the second axis B downwardly through the second bottom wall 50 to a second shaft bottom end 62 and upwardly through the second cover 52 to a second shaft top end 64 for attachment to a temperature control device. The temperature control device could be a blend door, a cam, a gear, a valve, or any other device for controlling a temperature. The second shaft bottom end 62 presents a second slot 66 extending across the second shaft bottom end 62.

In the preferred embodiment, the second lever 58 is a pulley having a second radius and a second circumference. The second pulley 58 extends in a circle and presents a second channel 68 disposed along the second circumference of the second pulley 58. In the preferred embodiment, the first radius is the same as the second radius and the first circumference being the same as the second circumference. The pulleys may be selected to have different radii and circumferences. For example, the second pulley 58 may have a smaller second radius than the first radius of the first pulley 34 to increase the amount of rotation of the second pulley 58 relative to the rotation of the first pulley 34. The second pulley 58 may also be selected to have a larger second radius than the first pulley 34 increase the torque output from the second pulley 58 relative to the torque applied to the first pulley 34.

A cable 70, preferably of metal wire, engages and extends between the first and second pulleys 34, 58 for rotating the second pulley 58 in response to the rotation of the first pulley 34. The cable 70 has a first cable end 72 entrained in the first channel 46 of the first pulley 34 and has a second cable end entrained in the second channel 68 of the second pulley 58. In the preferred embodiment, the cable 70 is wrapped one full turn around each of the first and second pulleys 34, 58. A conduit 74, preferably of an organic polymeric material, is disposed about the cable 70 and extends between the first and second housings 22, 48 for guiding and shielding the cable 70.

A first spring 76 engages the first bottom wall 24 of the first housing 22 and the first shaft bottom end 40 for applying a first pre-determined force to continually bias the first pulley 34 to rotate in a first direction. A second spring 78 engages the second bottom wall 50 of the second housing 48 and the second shaft bottom end 62 for applying a second pre-determined force to continually bias the second pulley 58 to rotate in a second direction being opposite of the first direction. The biasing of the second pulley 58 counterbalances the biasing of the first pulley 34 and maintains tension in the cable 70.

In the preferred embodiment, the first and second springs 76, 78 each include a strip of metal wound into a spiral for applying a torque on the first pulley 34 and the second pulley 58 respectively. However, any other type of spring or combination of springs capable of exerting a torque on the first pulley 34 or a tension force on the cable 70 may be used.

In the preferred embodiment, the first pre-determined force is equal to the second predetermined force in magnitude. The springs 76, 78 are preferably designed to provide a near-constant force on the cable 70 throughout the range of deflection the assembly uses. This may be achieved by selecting springs having a large number of coils and a small spring constant for the first and second springs 76, 78. Friction in the system holds the assembly in an adjusted position after the control knob 44 has been turned. When the control knob 44 is manually turned, the first and second springs 76, 78 will not be evenly counterbalanced because one spring will apply an overriding force as the other spring force will be slightly relieved by manual input. The equilibrium is maintained by friction to hold the cable 70, and thus, the pulleys 34, 58 in the adjusted position.

A first shield 80 is disposed axially below and engages the first bottom wall 24 of the first housing 22 for holding and protecting the first spring 76. A second shield 82 is disposed axially below and engages the second bottom wall 50 of the second housing 48 for holding and protecting the second spring 78.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A cable assembly for rotating a temperature control device in response to a rotating input, comprising:
a first housing,
a first lever rotatably mounted to said first housing for rotating in a first operating range and for receiving a rotating input,
a second housing,
a second lever rotatably mounted to said second housing for rotating in a second operating range and for attachment to a temperature control device,
a cable engaging and extending between said first and second levers for rotating said second lever in response to the rotation of said first lever,
a first spring engaging said first housing and said first lever for applying a first constant force to bias said first lever to rotate in a first direction under said first constant force throughout said first operating range of said first lever to apply a predetermined tension force on said cable, and
a second spring engaging said second housing and said second lever for applying a second constant force to bias said second lever to rotate in a second direction under said second constant force opposite to said first direction to counterbalance said first spring and maintain tension in said cable whereby said first and second levers remain stationary at any point in said first and second operating ranges.

2. An assembly as set forth in claim 1 wherein said first pre-determined force is equal to said second pre-determined force in magnitude.

3. An assembly as set forth in claim 1 wherein said first spring includes a strip of metal wound into a spiral for applying a torque on said first pulley.

4. An assembly as set forth in claim 1 wherein said second spring includes a strip of metal wound into a spiral for applying a torque on said second pulley.

5. An assembly as set forth in claim 1 wherein said first lever is further defined as a first pulley having a circular shape and having a first radius and a first circumference and presenting a first channel disposed on said first circumference of said first pulley.

6. An assembly as set forth in claim 5 wherein said cable has a first cable end entrained in said first channel of said first pulley.

7. An assembly as set forth in claim 1 wherein said second lever is further defined as a second pulley having a circular shape and having a second radius and a second circumference and presenting a second channel disposed on said second circumference of said second pulley.

8. An assembly as set forth in claim 7 wherein said cable has a second cable end entrained in said second channel of said second pulley.

9. An assembly as set forth in claim 1 wherein said first housing includes a first bottom wall and a first cover being spaced from each other and said second housing includes a second bottom wall and a second cover being spaced from each other.

10. An assembly as set forth in claim 9 wherein said first lever includes a first shaft extending axially upward along said first axis through said first cover to a first shaft top end and extending axially downward along said first axis through said first bottom end to a first shaft bottom end.

11. An assembly as set forth in claim 9 wherein said second lever includes a second shaft extending axially upward along said second axis through said second cover to a second shaft top end and extending axially downward along said second axis through said second bottom wall to a second shaft bottom end.

12. An assembly as set forth in claim 9 wherein said first housing includes a first shield engaging said first bottom wall of said first housing for holding and protecting said first spring.

13. An assembly as set forth in claim 9 wherein said second housing includes a second shield engaging said second bottom wall of said second housing for holding and protecting said second spring.

14. An assembly as set forth in claim 1 wherein said cable is of metal wire.

15. An assembly as set forth in claim 14 including a conduit being of a polymeric material disposed about the metal wire cable and extending between said first and second housings for shielding said metal wire cable.
